(19) United States
(12) Patent Application Publication
(10) Pub. No.: US 2014/0069019 A1
(43) Pub. Date: Mar. 13, 2014

(54) Door Seal Apparatus

(71) Applicant: Diversified Structural Composites, Inc., Erlanger, KY (US)

(72) Inventors: Mark A. Back, Myrtle Beach, SC (US); Geoffrey C. Card, Venice, FL (US)

(21) Appl. No.: 14/024,065

(22) Filed: Sep. 11, 2013

Related U.S. Application Data
(60) Provisional application No. 61/699,683, filed on Sep. 11, 2012.

(51) Int. Cl. E06B 7/22; E06B 7/24

(52) U.S. Cl. CPC E06B 7/22; E06B 7/24
USPC 49/484.1; 49/498.1

(57) ABSTRACT

A device for providing a seal between a door and at least a part of a doorway includes a door sash having a length, a hinged edge, a front portion, a back portion, and a plurality of curls on the hinged edge. The device also includes a door jamb proximal to the hinged edge, a door stop, a weather strip configured to engage the door sash and adapted to provide a first seal when the door is in the closed position, and a plurality of sealing members extending from the curls and adapted to provide at least a second seal between the door sash and the jamb.

### TECHNICAL FIELD

This disclosure generally to sealing doorways from thermal, air, sound, pest and other influences.

### BACKGROUND

It is often necessary and advantageous to provide a sealing mechanism on doors to provide thermal, air, and sound insulation and to prevent the entry into a structure of pests such as bugs. Currently in the prior art there are door sealing mechanisms which provide thermal, air, or sound insulation. Most door seals provide a single weather strip made of an elastomeric or similar material. None of these, however, provide all three types of insulation while also keeping out pests. Therefore, there is a need in the art for a sealing apparatus which provides thermal, air and sound insulation while also providing a barrier against bugs and other pests.

### SUMMARY

It is an object of the present invention to provide a sealing apparatus that provides thermal, air, and sound insulation while providing a barrier against pests. In one embodiment, a device for providing a seal between a door and at least a part of a doorway when the door is in a closed position is provided. The device includes a door sash having a length, a hinged edge, a front portion, a back portion, and a plurality of curls on the hinged edge; a door jamb proximal to the hinged edge; a door stop; at least one weather strip, configured to engage the door sash and adapted to provide a first seal when the door is in the closed position; and a plurality of sealing members extending from the curls and adapted to provide at least a second seal between the door sash and the jamb when the door is in the closed position.

### BRIEF DESCRIPTION

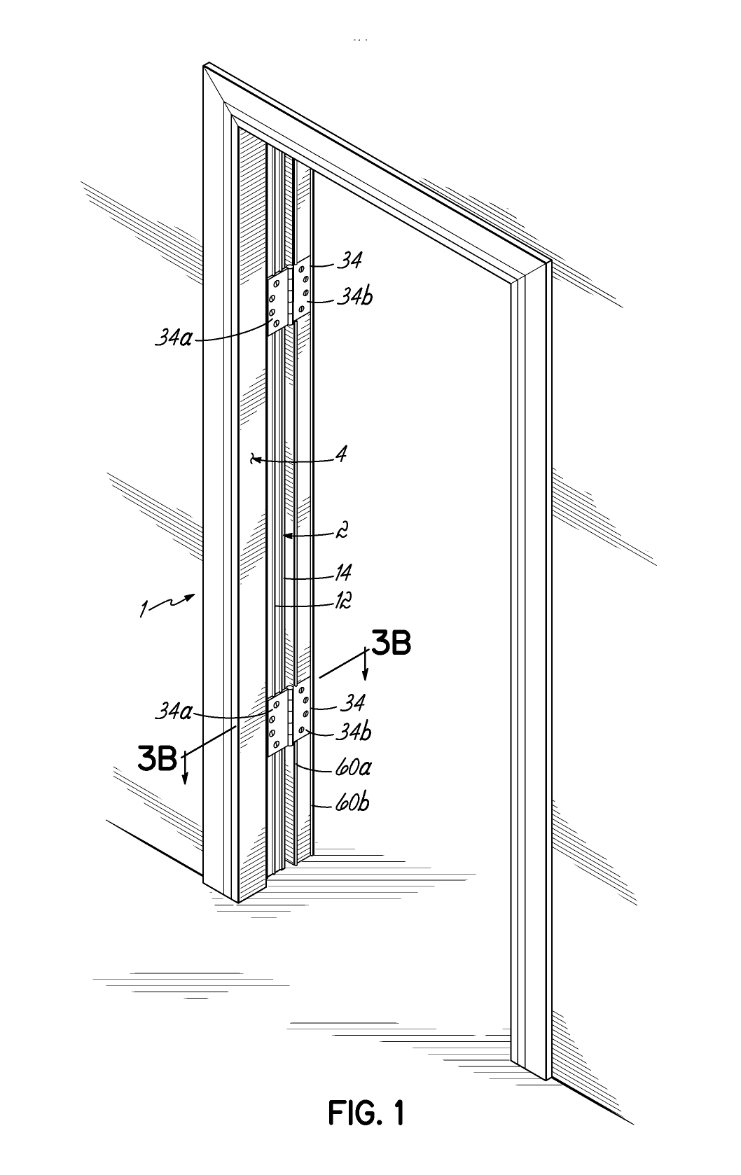

FIG. 1 is a perspective view of a door assembly with a door sash shown in an open position, including a door jamb and stop.

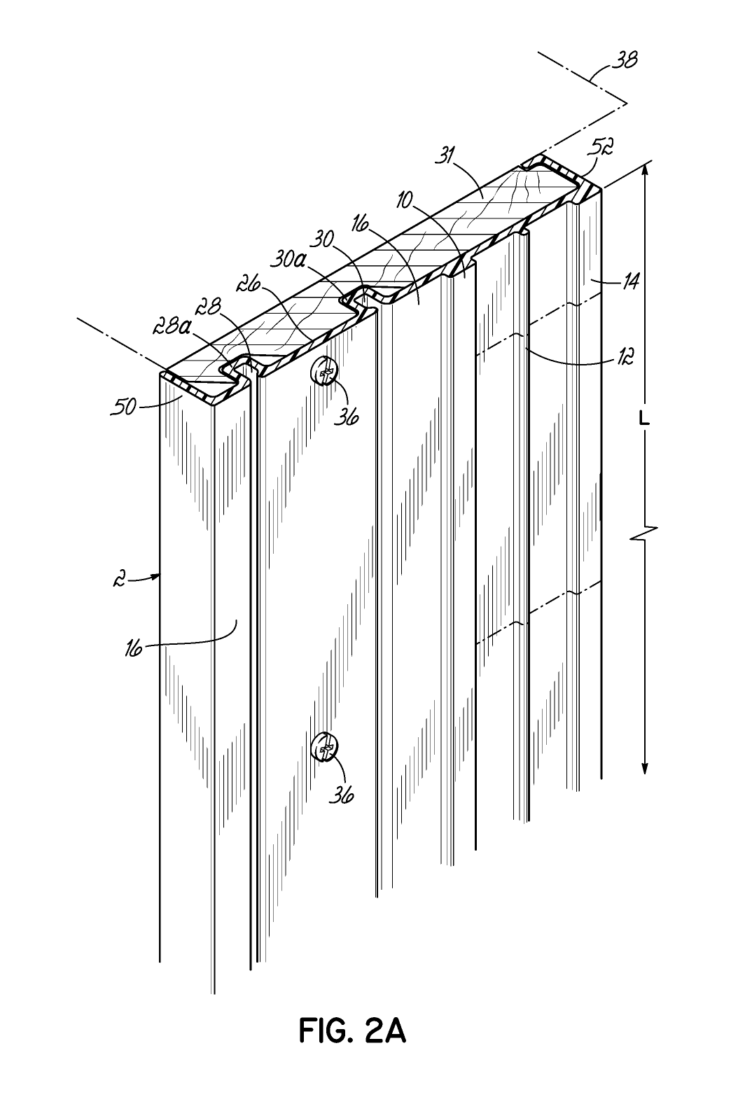

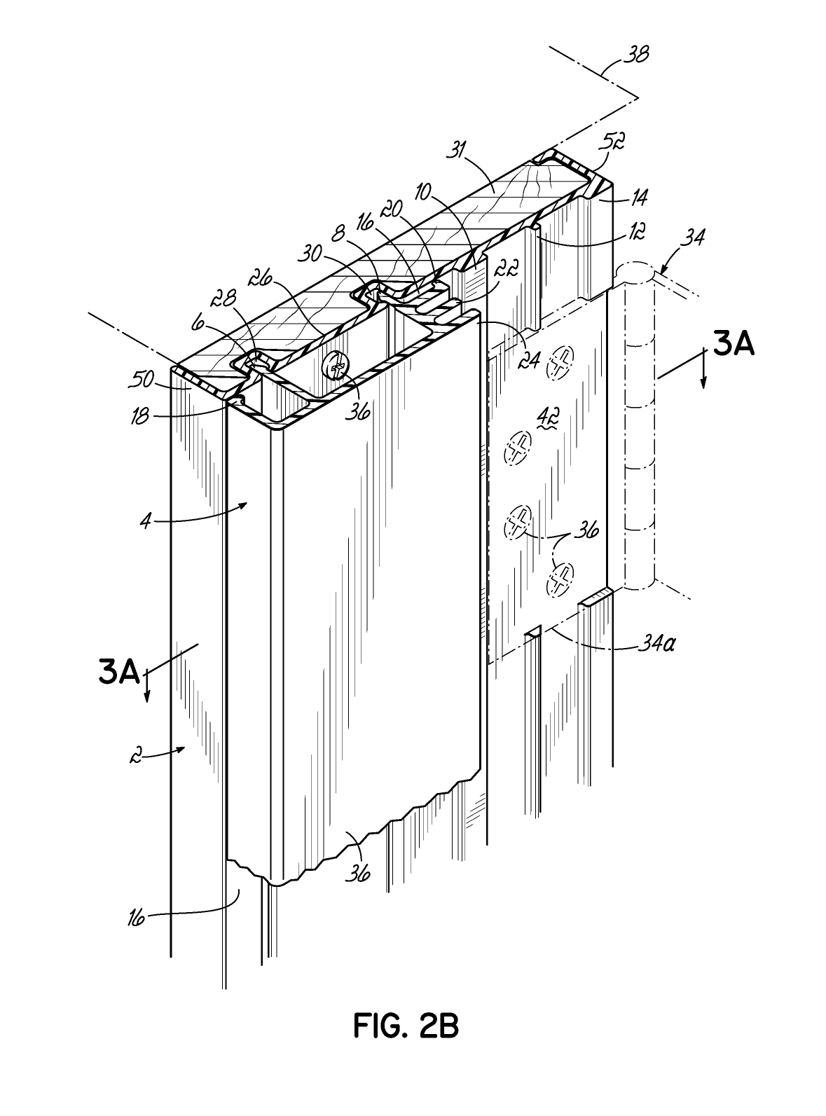

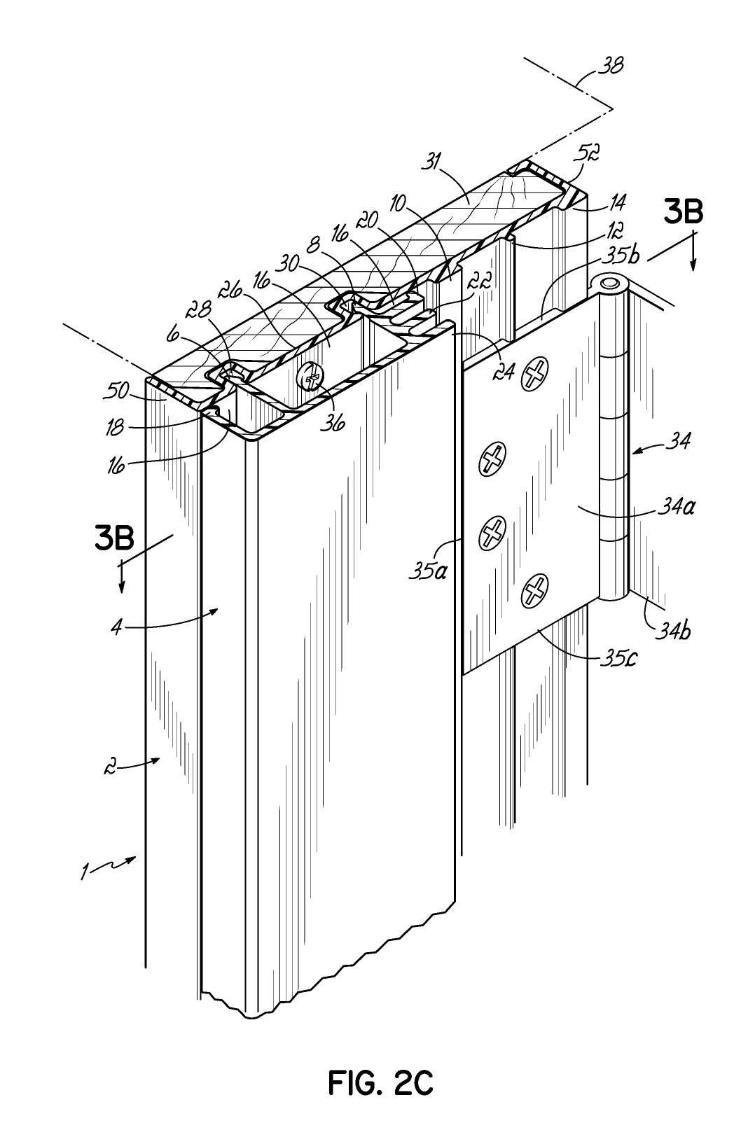

FIG. 2A is a perspective view partially in cross-section showing a door jamb fixed to a door frame.

FIG. 2B is a perspective view partially in cross-section showing a door jamb fixed to a door frame and also including a door stop.

FIG. 2C is a perspective view partially in cross-section showing a door jamb fixed to a door frame and also including a door stop and a hinge.

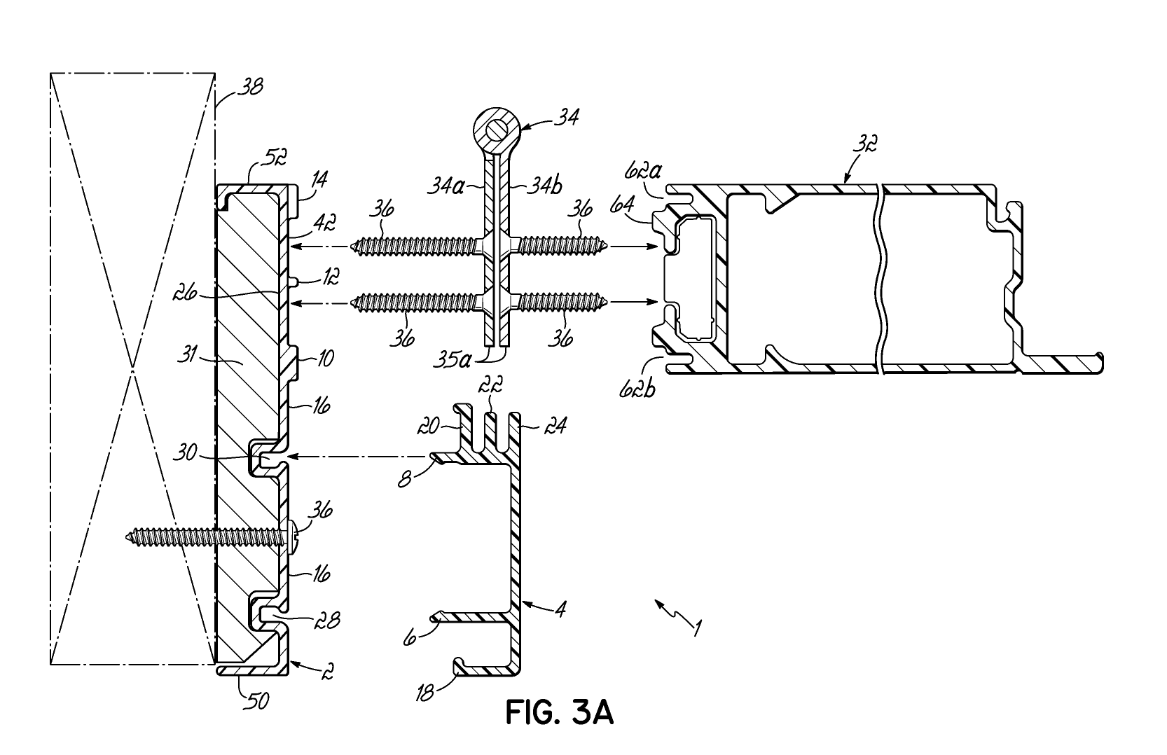

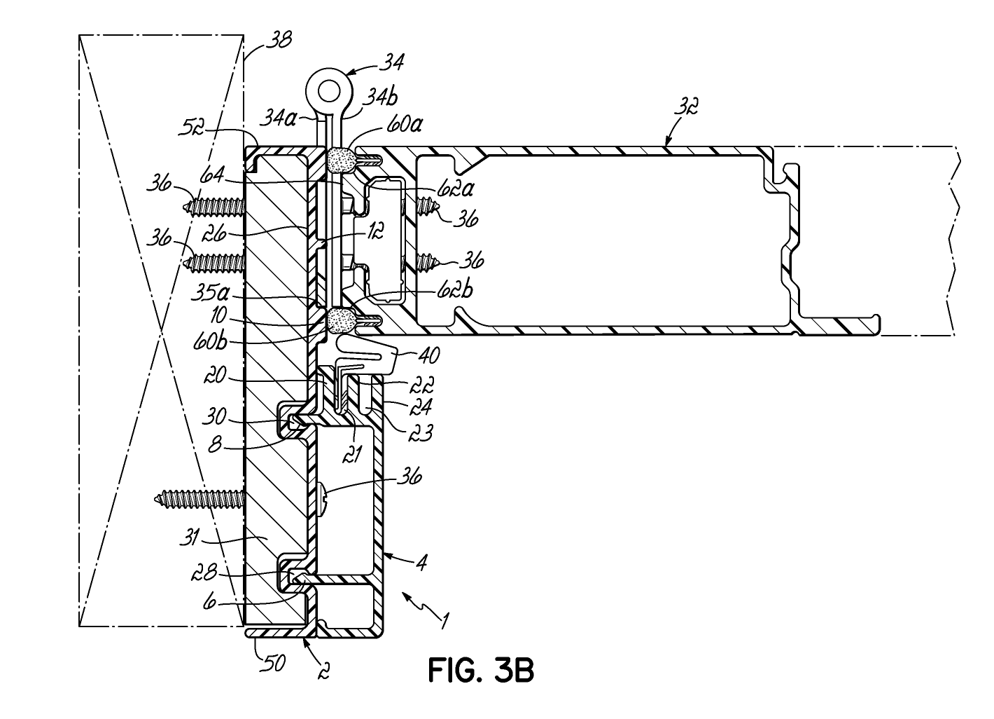

FIG. 3A is a cross-sectional view taken on line 3A-3A of FIG. 2B showing an exploded door assembly.

FIG. 3B is a cross-sectional view taken on line 3B-3B of FIG. 2C showing a door assembly.

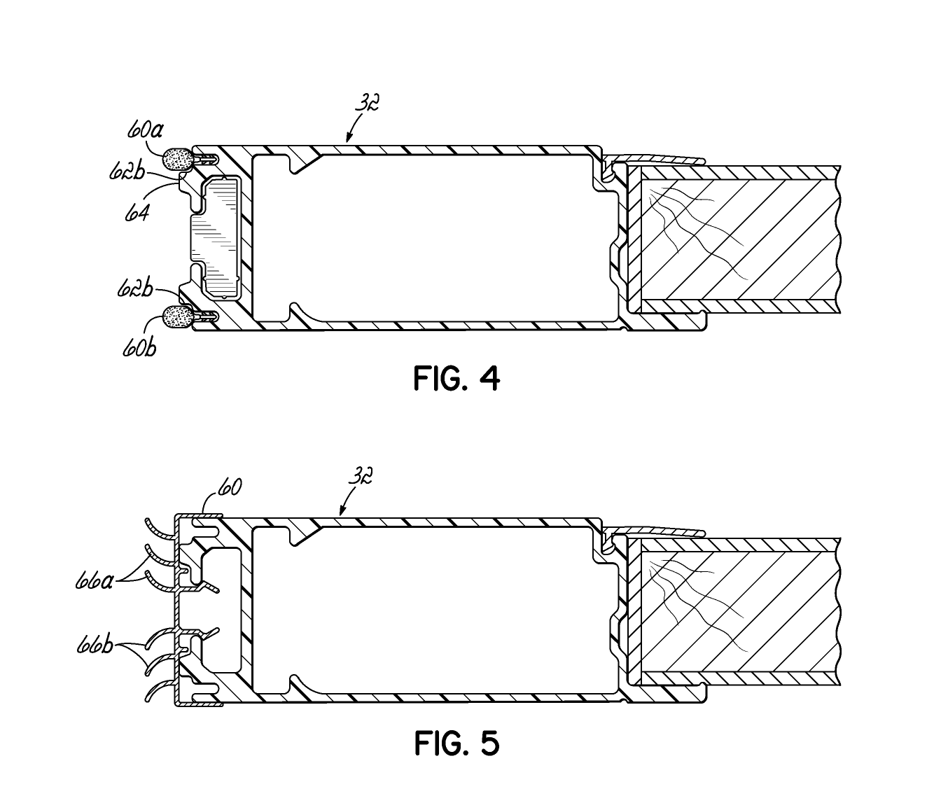

FIG. 4 is a top-cross sectional view showing a door sash containing sealing members.

FIG. 5 is a top-cross sectional view showing a door sash containing an alternative embodiment of sealing members.

### DETAILED DESCRIPTION

FIG. 1 is a perspective view of a door assembly portraying the assembly 1 including a door jamb 2 and stop assembly 4 fixed to a door frame.

As seen in FIG. 2A, jamb 2 includes a contact surface 16, a frame surface 26, first and second flanges 50, 52 extending proximally from the contact surface 16 and frame surface 26. An opening along the length L forms first and second channels 28, 30 extending proximally from the contact surface 16 along a length L of the jamb 2. Channels 28, 30 preferably are shaped to accept the first and second legs 6 and 8 of stop assembly 4, respectively (see FIGS. 2B and 2C), to form an interference fit, but may be formed in a different manner to be fastened in an alternative way, such as using mechanical fasteners.

Jamb 2 has a frame surface 26 which is fixed to a door frame 31 by means of a plurality of screws 36, but other types of fasteners such as staples may be used. The door frame 31 may be configured to accept the protrusions 28a and 30a due to channels 28 and 30 and other portions of the jamb 2. The screws 36 may be applied along the length L of the jamb 2 and may be concealed when the legs 6, 8 of stop assembly 4 are fit into the channels 28 and 30, respectively (see FIGS. 2B and 2C) and the stop is engaged with the jamb 2. The flanges 50 and 52 may have a complementary shape with the door frame 31 that allows for easy installation and an aesthetically pleasing look after final installation. For example, in FIG. 2A, the flange 52 of jamb 4 has a “C-shape” to conceal one end of the door frame 31.

Referring to FIGS. 2B and 2C, the first and second arms 18, 20 of the stop assembly 4 may engage the contact surface 16 of jamb 2 when the legs 6,8 are engaged with the channels 28,30. This engagement between the first and second arms 18, 20 and the contact surface 16 helps to prevent legs 6, 8 from progressing too far proximally in channels 28, 30. The stop 4 being fixed with respect to the jamb 4 at a point where the screws 36 will be concealed gives the entire assembly 1 a more aesthetically pleasing look when assembled and installed on a door frame 31, due to the concealed nature of the screws 36.

The ribs 10, 12, and 14 may be of a suitable height in order for the hinge 34 to lay flush with the ribs 10, 12 and 14 in the machined space 42. The jamb 2 is manufactured having the ribs 10, 12 and 14 along the entire length. When received by the customer, who may be an installer of doors, windows and similar fixtures, the customer may cut the pieces of jamb 2 and stop 4 in order to comply with the end user's specifications. In order to accommodate for door hinges 34, the customer may also machine spaces 42 (shown in phantom) out of the second and third ribs 12, 14 according to the size of standard door hinges in the industry, or alternatively, hinges which are custom to a particular customer or client.

The hinge 34 is fixed to the door frame 31 by fasteners such as screws 36, which are screwed through holes in the hinge 34 and through the jamb 2 and into the door frame 31 and wall 38 (see FIGS. 3A and 3B). Each hinge 34 has first, second and third edges 35a, 35b, 35c. On each hinge 34, each first edge 35a substantially abuts the first rib 10, and each second and third edge 35b, 35c substantially abut both the second and third ribs 12, 14. The portions of the first, second and third ribs 10,12 and 14 which are essentially in contact with the edges 35a, 35b, 35c of hinge 34 provide additional support for the hinge 34 and door sash 32 when the hinge is experiencing forces from the weight of the door and outside forces, in both static and dynamic conditions.

In a preferred embodiment, the first and third ribs 10, 14 have a larger width than the second rib 12. This particular arrangement provides manufacturing benefits such as ease of manufacturing and cost savings due to less material being used from the smaller width of material such as fiberglass. However, different configurations also realizing similar or different manufacturing and other benefits may be utilized.

As seen in FIG. 3B, the stop 4 also accepts a door when it is part of a door sash 32, door frame and door jamb assembly as seen in Figure. There may be a weather stripping 40 disposed in the space 21 between the second and third arms 20, 22 of the stop 4 to aid the stop in stopping the door sash 32. Alternatively, the weather stripping 40 may be disposed at a different part of the stop 4 or may be included as a part of the stop 4. Further, alternatively, there may be an additional sealing member in the space 23 between third and fourth arms 22, 24 or a single sealing member at in between second and third arms 20, 22 or between third and fourth arms 22, 24.

The door jamb 2 and stop assembly 4 may be manufactured into elongated portions, either by extrusion or pull-trusion, or any other suitable method of manufacture. After manufacture, the individually manufactured pieces of jamb 2 and stop 4 will be shipped in preferably fourteen-foot-long pieces, but may be shipped in any length suitable to the manufacturer or customer. When received by the customer, who may be an installer of doors, windows and similar fixtures, the customer may cut the pieces of jamb 2 and stop 4 in order to comply with the end user's specifications. In order to accommodate for door hinges, the customer may also machine spaces 42 out of the second and third ribs 12, 14 according to the size of standard door hinges in the industry, or alternatively, hinges which are custom to a particular customer or client. A jamb 2 with a machined space 42 for a hinge 34 is shown in FIGS. 2A and 2B (in phantom).

In a preferred embodiment, the entire assembly 1 includes two components, the jamb 2 and the stop 4. In other embodiments, however, the assembly may include more than two components. For example, the jamb 2 or the stop 4 may comprise multiple sub-components to be assembled together.

FIGS. 3A and 3B show the assembly 1 as part of a full door assembly. The jamb 2 is fixed to the door frame 31 by a plurality of screws 36 extending through the door frame 31 and into the wall or other structure 38. Preferably, particular portions of second and third ribs 12, 14 have been machined down so stationary portion 34a of hinge 34 can lay flush in a machined space 42 among portions of the first, second and third ribs 10, 12 and 14. The stationary portion 34a of the hinge 34 is fastened to the jamb 2, door frame 31 and wall 38 by means of a screw 36 or other fastener. The legs 6, 8 of stop assembly 4 are fit into the channels 28 and 30 of the jamb 2, respectively. Preferably, there is an interference fit between the respective legs 6, 8 and channels 28, 30 to ensure a secure fit of the stop assembly 4 with the jamb 2. The placement of legs 6, 8 within channels 28, 30 will also cause arms 18 and 20 to engage the contact surface 16 of the jamb 2. This placement of the stop assembly 4 preferably conceals the screws 36.

Door sash 32 will be fixably connected to rotatable component 34b of hinge 34, making it rotatably fixed with respect to stationary component 34a of hinge 34, door jamb 2, and door stop assembly 4. When door is in the closed position as shown in FIG. 3B, at least a portion of door sash 32 will rest against or be accepted by either the stop 4 or an optional weather stripping 40. The weather stripping 40 may be disposed between the second and third arms 20, 22 of the stop. Alternatively, the weather stripping may be disposed at a different part of the stop or may be included as a part of the stop. The weather stripping 40 may be integrated into door stop assembly 4 to form a unitary item or may be a separately manufactured component as part of a multi-part assembly.

A method of assembling a door frame assembly is provided, including manufacturing a door jamb 2 having a length L and a contact surface 16. The door jamb further has first and second channels 28, 30 along the length L. Each channel 28, 30 has an opening at the contact surface 16 and extends distally from the contact surface 16. The jamb 2 also has first, second and third ribs 10, 12 and 14 which extend proximally from the contact surface 16 of the jamb 2. The method also comprises machining the second and third ribs 12, 14 at multiple points along the length L to create a plurality of spaces 42 (shown in phantom) for the placement of a plurality of hinges 34. The machined spaces 42 are disposed among the first second and third ribs 10, 12 and 14 as seen in FIGS. 2A-2B. The method further comprises fixing a hinge 34 into each space 42. Each hinge 34 has first, second and third edges 35a, 35b, 35c. On each hinge 34, each first edge 35a substantially abuts the first rib 10, and each second and third edge 35b, 35c substantially abut both the second and third ribs 12, 14 while engaged within the machined space 42. The method further comprises fixing a door stop assembly 4 to the jamb 2. The door stop assembly 4 comprises a weather stripping 40 which may accept a door sash 32 when the door is in a closed position. The door stop assembly 4 has first and second legs 6, 8 adapted to be detachably fixed within the first and second channels 28, 30 due to, for example, an interference fit.

With continuing reference to FIG. 3B and additionally FIG. 4, sealing members 60a, 60b are disposed within channels or curls 62a, 62b along the length of hinged edge 64. The sealing members 60a, 60b may be fixed to the curls 62a, 62b by an adhesive or alternatively a mechanical or other suitable means. In a preferred embodiment, the sealing members 60a, 60b include seal weather bulbs comprised of a material capable of providing thermal, air, and sound insulation as well as a barrier against pests. An alternative embodiment of sealing members 60 comprising a plurality of flexible strips 66a, 66b is shown in FIG. 5.

When the door is in the closed position, the weather stripping 40 on the stop 4 provides a first seal between the sash 32 and the jamb 2. The sealing members 60a and 60b may engage with first and third ribs 10, 14 create second and third seals. In a preferred embodiment, three seals are created. In alternative embodiments, there may be more or less seals created by more or less sealing members 60 disposed along the hinged edge 64 of door sash 32. The sealing members 60 may also be comprised of shapes and configurations other than those pictured in the figures. Alternatively, there may be multiple spaces 21, 23 of stop 4 adaptable to accept multiple weather strips 40 which may create one or more seals.

From the above disclosure of the general principles of the present invention and the preceding detailed description of at least one preferred embodiment, those skilled in the art will readily comprehend the various modifications to which this invention is susceptible. Therefore, we desire to be limited only by the scope of the following claims and equivalents thereof.

What is claimed is:

1. A device for providing a seal between a door and at least a part of a doorway, comprising:
a door sash having a hinged edge and a plurality of curls on the hinged edge;
a door jamb proximal to the hinged edge;
a door stop;
at least one weather strip configured to engage the door sash and provide a first seal; and
a plurality of sealing members extending from the curls and adapted to provide at least a second seal between the door sash and the jamb.

2. The device of claim 1, further comprising:
first and second curls; and
first and second sealing members extending from the curfs, wherein the first and second sealing members are adapted to engage the door jamb and provide at least an additional seal between the door sash and the jamb when the door is in the closed position.

3. The device of claim 1, wherein the sealing members comprise bulb weather seals.

4. The device of claim 2, wherein the first and second sealing members comprise bulb weather seals.

5. The device of claim 1, wherein the first and second sealing members each include a plurality of flexible strips.

6. The device of claim 1, wherein the door jamb includes at least one rib extending distally therefrom and being configured to engage at least one of the plurality of sealing members to form the at least second seal between the door sash and the door jamb when the door is in the closed position.

7. The device of claim 1, wherein the door jamb has first and second ribs extending distally therefrom and being configured to engage with first and second sealing members on the hinged edge to form a second and third seal between the door sash and the jamb.

8. The device of claim 7 wherein the first and second sealing members are disposed within first and second curls on the hinged edge.

9. The device of claim 8 wherein the first and second sealing members are bulb weather seals.

10. The device of claim 8 wherein the first and second sealing members each include a plurality of flexible strips.

11. The device of claim 1, wherein the stop comprises a plurality of spaces, each space adapted to accept at least one weather strip.

12. The device of claim 1, wherein:
the stop further comprises first and second spaces and first and second weather strips fixed at least partially within the first and second spaces, respectively; and
wherein the first and second weather strips are configured to engage the door sash and adapted to provide a first set of seals when the door is in the closed position.

13. A device for providing a seal between a door and at least a part of a doorway, comprising:
a door sash having a hinged edge and a plurality of curls on the hinged edge;
a door jamb proximal to the hinged edge;
a door stop;
at least one weather strip configured to engage the door sash and provide a first seal; and
a plurality of sealing members extending from the curls and adapted to provide at least a second seal between the door sash and the jamb;
wherein the stop further comprises first and second spaces and the sealing members include first and second weather strips fixed at least partially within the first and second spaces, respectively; and the first and second weather strips are configured to engage the door sash and adapted to provide a first set of seals when the door is in the closed position.

14. The device of claim 13, wherein the door jamb has first and second ribs extending distally therefrom and being configured to engage with first and second sealing members on the hinged edge to form a second and third seal between the door sash and the jamb.

15. The device of claim 14 wherein the first and second weather strips are disposed within first and second curfs on the hinged edge.
